(19) United States
(12) Patent Application Publication
(10) Pub. No.: US 2009/0244643 A1
(43) Pub. Date: Oct. 1, 2009

(54) SYSTEM FOR PLATE IMAGING AND PROCESSING

(76) Inventors: Yoav Telem, Kfar-Schmaryahu (IL); Moshe Marom, Kfar Saba (IL); Kalman Shamir, Herzlia (IL)

Correspondence Address: Amelia A. Buharin;Patent Legal Staff, Eastman Kodak Company, 343 State Street, Rochester, NY, 14650-2201, US

(21) Appl. No.: 12/058,836

(22) Filed: Mar. 31, 2008

(51) Int. Cl. H04N 1/40

(52) U.S. Cl. 358/3.29

(57) ABSTRACT

A system for enhanced plate processing including an imaging device (12) for imaging printing plates and a plate processing device for processing imaged plates. A system controller (21) is configured to send and receive information to the imaging device and the plate processing device.

### FIELD OF THE INVENTION

The present invention relates to printing plate imaging and processing and more specifically to a system for automatically adjusting plate imaging and processing parameters.

### BACKGROUND OF THE INVENTION

When changing plate size or plate thickness the plate processor operator must update the processor parameters in order to comply with the characteristics of the incoming plate. The parameters are changed manually by the operator on the processor's front panel. Since this is a manual operation it requires the presence of an operator next to the processor. The processor cannot accurately measure the characteristics of the plate before plate processing or during plate movement inside the processor. This limitation requires operator intervention every time plates of different characteristics are to be processed by the same processor.

Some of the plate processors are capable of estimating, to a limited extent, the size of the incoming plate. Such processors have a pre-installed sets of predefined setup parameters, which is selected automatically, usually according to the length of an incoming plate. The actual plate width, plate thickness, and plate type are not taken into consideration, thus providing a limited solution for processing different types of plates in the plate processor. Although there are few processors with remote control capabilities it does not include direct connection to the computer-to-plate (CTP) imaging device, and thus an unattended plate processing for different types of plates is not possible with the processor.

FIG. 1 describes a prior art plate production system 10 including a CTP device for imaging plates configured to output imaged plates directly into a plate processor. Plates are loaded into the system by plate cassette loader 11, which is equipped with plurality of plate trays 17. Typically each tray is configured to carry plates of different sizes. A non-imaged plate 15 is fetched from one of the plate trays 17 and loaded into imaging device 12. The imaging device 12 images non-imaged plate 15 to create an imaged plate 15A. After receiving a ready signal on control line 18 from the plate processor, the imaging device 12 ejects imaged plate 15A onto plate conveyor 14 to be directly transported into plate processor 13 for plate processing. The ready signal (on control line 18) indicates that there is no previously imaged plate being transported on plate conveyor 14. The control line 18 will transmit a busy signal if plate sensor 16 detects a previously imaged plate being transported on plate conveyor 14. The plate sensor 16 is located on the incoming side of plate processor 13. Imaged plate 15A enters plate processor 13 and is processed to create a processed plate 15B which is ejected onto plate conveyor 14A.

Knowing the plate characteristics before processing of the plate and adjusting the processor parameters accordingly in an automatic fashion can improve plate processing productivity. For example, such a feature should enable plate producers to process various types of plates during a night shift without a presence of an operator, thus increasing plate processing productivity.

### SUMMARY OF THE INVENTION

Briefly, according to one aspect of the present invention a system for yielding enhanced processed plates in a plate production system comprises at least one imaging device imaging printing plates directly into a plate processing device, and at least one plate processing device is configured to directly receive imaged plates from the imaging device. A system controller sends and receives information to communicate to the imaging device and to the plate processing device.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustration of a prior art plate production system including a multi-cassette plate loader, a device for imaging plates, and a plate processor; and

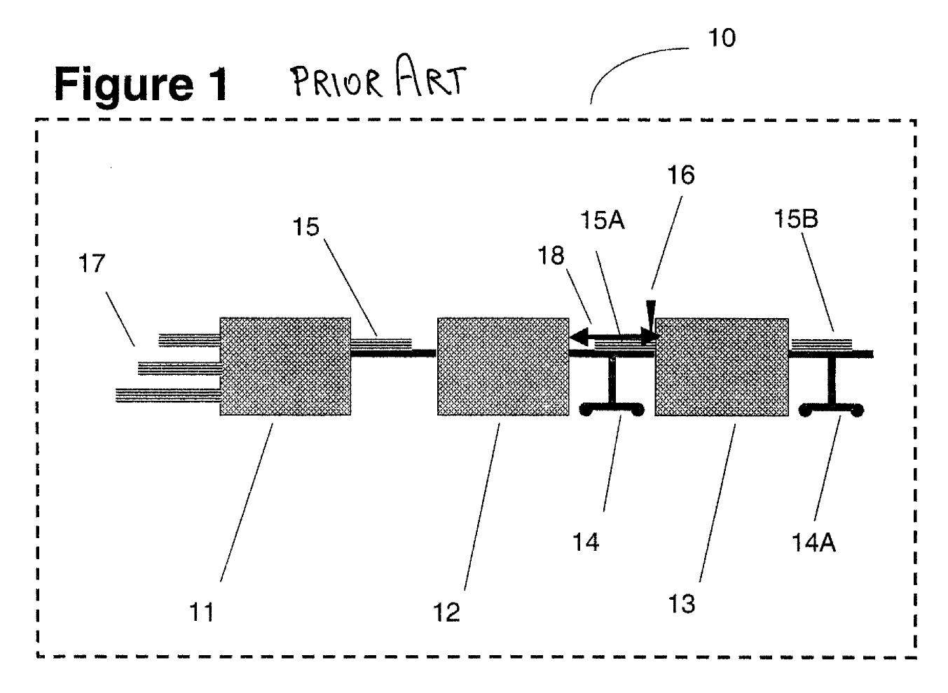

FIG. 2 is a schematic illustration of a plate production system according to the present invention.

### DETAILED DESCRIPTION OF THE INVENTION

In the following detailed description, reference is made to the accompanying drawings which form a part hereof, and in which is shown by way of illustration specific embodiments in which the method and apparatus may be practiced. Because components of embodiments of the present apparatus can be positioned in a number of different orientations, the directional terminology is used for purposes of illustration and is in no way limiting.

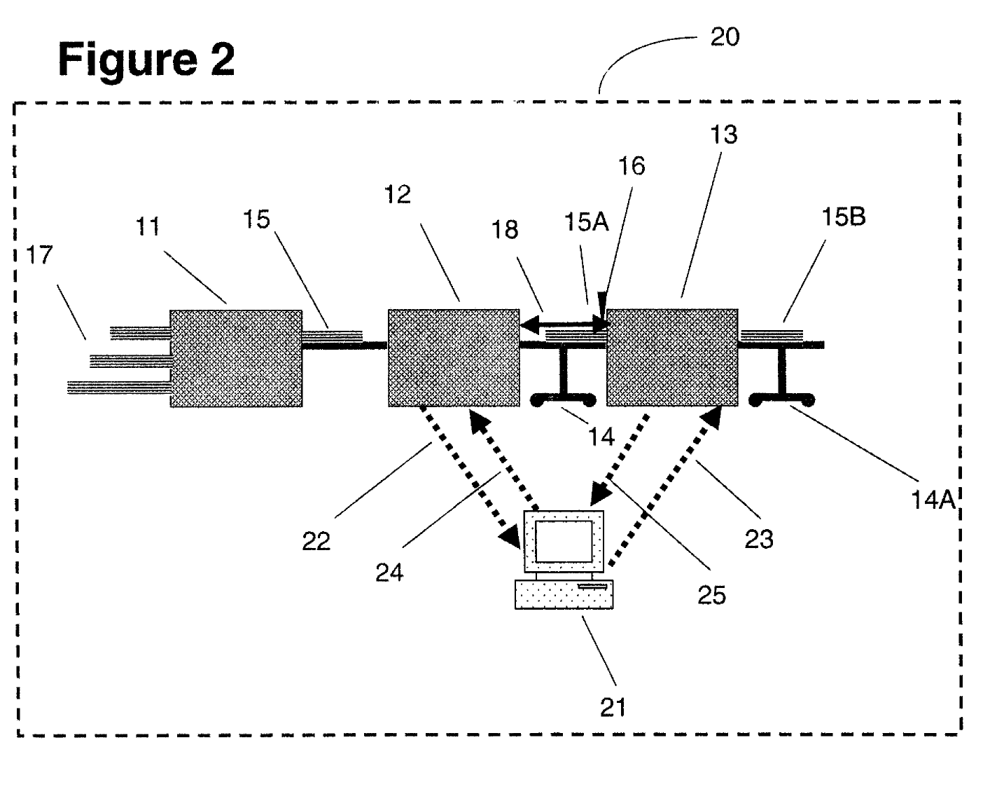

The apparatus and method utilizes plate characteristics, imaging characteristics, processing characteristics, and processed plate measurement information. FIG. 2 shows an embodiment of a plate production system 20 including a computer-to-plate (CTP) device for imaging plates which shares plate and imaging characteristics information and a plate processor which shares processing characteristics and plate measurement information. Plate production system 20 is an enhancement of plate production system 10, characterized by introducing a system controller 21 configured to process and share information between a CTP imaging device 12 and a plate processor 13.

System controller 21 receives plate and imaging characteristics 22 information from imaging device 12 as well as processor condition characteristics, plate measurement information, and parameters 25 from plate processor 13. For example, purpose characteristics 22 information may include plate size, thickness, plate vendor, and imaged plate ink coverage, whereas parameters 25 might include conductivity level, pH level and age of the chemistry in the processor, or other processor elements condition such as developer brush condition.

System controller 21 processes information derived from plate and imaging characteristics 22 and parameters 25 to create the following adjusted information:
1. Adjusted processor properties 23 complying with plate and imaging characteristics.
2. Adjusted CTP imaging device properties 24 due to the derived processing conditions as well as actual measured dot information from previously processed plates.

The adjusted processor properties 23 are sent from system controller 21 to plate processor 13 to adjust processor parameters for the incoming imaged plates 15A to be processed. Upon receiving the parameters of the new incoming imaged plate 15A, plate processor 13 will compare them to the last processed plate 15B conditions. In case the conditions of imaged plate 15A and processed plate 15B are different processor 13 will update processing parameters to comply with the incoming imaged plate 15A conditions. For example, the processor setup parameters might include elements such as: developer temperature, dwell time, and replenish quantity. The adjusted imaging device properties 24 will be sent from system controller 21 to the CTP imaging device 12 in order to adjust the CTP imaging properties to comply with the derived plate processor 13 conditions. This may result in an adjusted curve function or an adjusted laser intensity scheme in the imaging device 12 to comply with the plate processor 13 processing conditions yielding imaged plates with better printing results.

System controller 21 can be an independent element connected to both plate processor 13 and imaging device 12 via common communication lines. System controller 21 can be integrated in plate processor 13 communicating with imaging device 12, or vice versa, integrated in imaging device 12 and communicating with plate processor 13, or any combination of the above.

The communication between system controller 21 and plate processor 13 and imaging device 12 are implemented using a dedicated communication protocol.

The invention has been described in detail with particular reference to certain preferred embodiments thereof, but it will be understood that variations and modifications can be effected within the scope of the invention.

### PARTS LIST

10 plate production system
11 plate loader
12 imaging device
13 plate processor
14 plate conveyor (transferring imaged plates)
14A plate conveyor (receiving processed plates)
15 non-imaged plate
15A imaged plate
15B processed plate
16 plate sensor
17 plate trays
18 control line between CTP and processor
20 plate production system
21 system controller
22 plate and imaging characteristics
23 adjusted processor properties
24 adjusted CTP properties
25 processor condition characteristics and parameters

1. A system for enhanced plate processing comprising:
a) at least one imaging device for imaging printing plates;
b) at least one plate processing device for processing said imaged plates; and
c) a system controller configured to send and receive information to said imaging device and to said plate processing device.

2. The system according to claim 1 wherein said system controller:
a) receives plate imaging characteristic information from said imaging device; and
b) receives plate processor condition information from said plate processing device.

3. The system according to claim 2 wherein said system controller calculates adjusted imaging properties information according to said plate imaging characteristic information and plate processor condition information; and
sends said imaging properties information to said imaging device.

4. The system according to claim 2 wherein said system controller calculates adjusted plate processor properties information according to said plate imaging characteristic information and plate processor condition information; and
sends said adjusted plate processor properties information to said plate processing device.

5. The system according to claim 2 wherein said plate imaging characteristic information is selected from a group consisting of: plate size, thickness, type, vendor, laser intensity, or combination thereof.

6. The system according to claim 2 wherein said plate processor condition information is selected from a group consisting of:
developer temperature, dwell time, replenish quantity;
conductivity level, pH level, age of the chemistry;
developer brush condition; and
measured dot percent of a previously processed plate, or a combination thereof.

7. The system according to claim 3 wherein said adjusted imaging properties information comprises at least from the following parameters: laser intensity and imaging data.

8. The system according to claim 4 wherein said adjusted plate processor properties is selected from a group consisting of: processing program, developer temperature, dwell time, replenish quantity, brush speed, or a combination thereof.
